(19) United States
(12) Patent Application Publication
(10) Pub. No.: US 2008/0148010 A1
(43) Pub. Date: Jun. 19, 2008

(54) SEMICONDUCTOR INTEGRATED CIRCUIT

(76) Inventor: Tomoyuki KODAMA, Kokubunji (JP)

Correspondence Address: MILES & STOCKBRIDGE PC, 1751 PINNACLE DRIVE, SUITE 500, MCLEAN, VA, 22102-3833, US

(21) Appl. No.: 11/957,005

(22) Filed: Dec. 14, 2007

(30) Foreign Application Priority Data
Dec. 15, 2006 (JP) 2006-337798

(51) Int. Cl. G06F 15/80; G06F 9/06

(52) U.S. Cl. 712/16; 712/E09.003

(57) ABSTRACT

The system design is facilitated by eliminating the increase in data transfer volume of the whole system. In order to facilitate the system design, there are provided an operation unit array, a memory array, a data transfer circuit, and a switch circuit. There are also provided a configuration data management unit for managing the configuration data defining the logical behaviors of the operation unit array, the memory array, the data transfer circuit, and the switch circuit, as well as a state transition management unit capable of controlling the switching of the configuration data. The data transfer circuit includes a control circuit capable of autonomously sorting the data by determining the timing of the data sorting according to the setting included in the configuration data.

### CLAIM OF PRIORITY

The present application claims priority from Japanese application JP 2006-337798 field on Dec. 15, 2006, the content of which is hereby incorporated by reference into this application.

### FIELD OF THE INVENTION

The present invention relates to a semiconductor integrated circuit, and more particularly to a technology which may be effectively applied, for example, to a flexible processor.

### BACKGROUND OF THE INVENTION

There is known a processor including an operation unit to perform a coarse-grained operation with a width of about 8 to 32 bits as a unit, in which the operation contents and data paths can be changed at high speed to balance the operational performance, circuit utilization ratio, and flexibility at high level. For example, as described in Patent document 1, efficient operation and control can be achieved by independently providing a data path unit for mainly performing operation and a state transition management unit for performing control. The data path unit has a configuration in which processors arranged in a matrix array are coupled by a programmable switch. The state transition management unit has a configuration to facilitate the realization of a state transition means. In this way, each of the units is realized with the specific configuration depending on the processing purpose. The processor capable of allowing instant switching between functions is called as “flexible processor”. [Patent Document 1] Japanese Patent Laid-Open No. 2001-312481

### SUMMARY OF THE INVENTION

Because of the wide spread of portable information devices having multimedia processing functions, such as video and sound, and wired and wireless functions, there is a demand to provide such devices reduced in size at low cost by mounting a data processor having high performance, high functionality, and low power consumption. On the other hand, the product value largely depends on quickly meeting various standards established in response to the development of technology. For this reason, it is necessary not only to reduce the product development time but also to extend the product life, by allowing functions to be easily changed or added by software after production.

Such a data processor may be realized by designing a dedicated logic circuit capable of changing only limited functions prepared in advance like a plurality of operation modes, and mounting a combination of the dedicated logic circuits as a dedicated LSI. Generally, the dedicated LSI could be the best means of realization in terms of achieving high performance and low power consumption. However, the functions may not be changed or added unless the dedicated LSI is redesigned, and the development time for the design may increase.

Further, the data processor may be realized by mounting a general purpose microprocessor to realize various processings by software including a series of command lines to be executed on the processor. In this case, it is possible to achieve a high functionality, including function change and addition, without changing the hardware of the data processor. However, even in the most-advanced microprocessor, only a few commands can be simultaneously executed. Thus, it is necessary to mount a processor that operates at a very high clock frequency in order to realize processing with high throughput in a data processor based on sequential processing of commands. As a result, the power consumption increases. In addition, a control logic (such as branch prediction) other than the operation is necessary in order to bring out the processing performance of the processor, so that the logic scale of the operation unit itself relatively decreases. As a result, the processing efficiency to the hardware scale may be reduced.

Still further, the data processor may be realized by using a reconfigurable LSI called FPGA (Field Programmable Gate Array). The FPGA has an internal configuration such that a large number of Lookup Tables (LUTs) are coupled by a bus in which the routing can be changed, in order to realize an arbitrary function in the LSI by reading the operation contents of the LUTs and the configuration data defining the coupling among the LUTs, from an external memory of the LSI. Basically, the operation contents of the LUTs and the coupling among the LUTs can be set on a per-bit basis. Thus, although the flexibility is high when a given function is realized in the LSI, the area overhead increases in the application field in which a multi-bit operation such as video and sound processing is mainly performed.

Here, according to the technology described in Patent document 1, waiting occurs in the operation units when the supply of data to the operation units is not ensured, resulting in insufficient performance. Thus, there is provided a method of preparing a built-in memory for storing the operation data and operation results to hide the transfer delay from an external memory and the like. The built-in memory includes a plurality of memory banks in order to simultaneously supply data or store operation results into the operation units. Such a built-in memory is designed as a memory having sequential addresses from a system to which a flexible processor is coupled. However, from the flexible processor, the built-in memory is recognized and distinguished as a plurality of memories each of which is used as a source or destination for a specific operation unit. Thus, in a case of data transfer between the external memory and the built-in memory of the flexible processor by CPU (Central Processing Unit), DMAC (Direct Memory Access Controller) and the like, an appropriate data arrangement may not necessarily be provided by a simply transfer. This is because of the difference between the features of the data arrangement suitable for the flexible processor operation and the data arrangement suitable for the data transfer by the DMAC. More specifically, in the former case, the data are often arranged in the built-in memories (or discrete addresses), while in the latter case, the data are arranged in sequential addresses. This can be avoided by statically arranging the data in the program generation, or rearranging the data by using the CPU or DMAC, or rearranging the data within the flexible processor using the operation units as a means of data transfer. However, in a system in which data is dynamically supplied, there is no other means of rearranging the data, except using the CPU and DMAC or within the flexible processor. Thus, the data rearrangement by the CPU and DMAC results in an increase in load to the CPU and DMAC, as well as an increase in transaction to the system bus. The data rearrangement performed within the flexible processor results in a reduction in the utilization rate and operational performance of the flexible processor. In addition, in the case of the data rearrangement by the CPU and DMAC, the load to the CPU, DMAC, and system bus varies depending on the utilization rate of the flexible processor and on whether the data are sorted, resulting in an increase of the difficulty of the whole system design including the task scheduling and the system bus bandwidth.

An object of the present invention is to provide a semiconductor integrated circuit for facilitating the system design.

The aforementioned and other objects and novel features of the present invention will become apparent from the description of the present specification and the accompanying drawings.

The following is a brief description of typical inventions of those disclosed herein.

That is, there are provided an operation unit array; a memory array; a data transfer circuit capable of changing the arrangement of data to be stored in the memory array; and a switch circuit capable of switching data transfer paths among the operation unit array, the memory array, and the data transfer circuit. Also provided are a configuration data management unit and a state transmission management unit. The configuration data management unit manages configuration data defining the logical behaviors in the operation unit array, the memory array, the data transfer circuit, and the switch circuit. The state transition management unit can control the switching of the configuration data. Further, the data transfer circuit is provided with a control circuit capable of autonomously sorting the data by determining the timing of the data sorting according to the setting included in the configuration data.

The following is a brief description of an effect obtained by the typical inventions of those disclosed herein.

According to the present invention, it is possible to provide a semiconductor integrated circuit for facilitating the system design.

### BRIEF DESCRIPTION OF THE DRAWINGS

FIG. 1 is a block diagram illustrating an example of configuration of a system LSI including a flexible processor which is an example of a semiconductor integrated circuit according to the present invention;

FIG. 2 is a block diagram illustrating an example of configuration of an operation unit array included in the system LSI shown in FIG. 1;

FIG. 3 is a block diagram illustrating an example of configuration of a built-in memory array included in the system LIS shown in FIG. 1;

FIG. 4 is a block diagram illustrating an example of configuration of a data transfer unit included in the system LSI shown in FIG. 1;

FIG. 5 is a diagram illustrating the configuration data to be stored in a configuration data register included the system LSI shown in FIG. 4;

FIG. 6 is a flowchart showing an outline of the processing of the data transfer unit shown in FIG. 4;

FIG. 7 is a block diagram illustrating another example of configuration of the system LSI including a flexible processor which is an example of the semiconductor integrated circuit according to the present invention;

FIG. 8 is a block diagram illustrating an example of configuration of a sequential data transfer unit included in the system LSI shown in FIG. 7;

FIG. 9 is a diagram illustrating the configuration data to be stored in a configuration data table included in the sequential data transfer unit shown in FIG. 8;

FIG. 10 is a flowchart showing an outline of the processing of the sequential data transfer unit shown in FIG. 8;

FIG. 11 is a block diagram illustrating another example of configuration of the system LSI including a flexible processor which is an example of the semiconductor integrated circuit according to the present invention;

FIG. 12 is a block diagram illustrating an example of configuration of a data compress and transfer unit included in the flexible processor shown in FIG. 11;

FIG. 13 is a diagram illustrating the configuration data to be stored in a configuration data register included in the data compress and transfer unit shown in FIG. 11;

FIG. 14 is a flowchart showing an outline of the processing of the data compress and transfer unit shown in FIG. 11;

FIG. 15 is a block diagram illustrating another example of configuration of the system LSI including a flexible processor which is an example of the semiconductor integrated circuit according to the present invention;

FIG. 16 is a block diagram illustrating an example of configuration of a stream data transfer unit included in the flexible processor shown in FIG. 15;

FIG. 17 is a diagram illustrating the configuration data to be stored in a configuration data register included in the stream data transfer unit shown in FIG. 15; and

FIG. 18 is a flowchart showing an outline of the processing of the stream data transfer unit shown in FIG. 15.

### DETAILED DESCRIPTION OF THE PREFERRED EMBODIMENTS

### 1. Typical Embodiment

First, a typical embodiment of the invention disclosed herein will be summarized. In the summary of the typical embodiment, the reference numerals in the drawings are referred to in parenthesis, which only show the components included the concepts of those designated by the reference numerals.

[1] A semiconductor integrated circuit according to the typical embodiment of the present invention, includes an operation unit array (102) formed by arranging a plurality of operation units each capable of performing a predetermined operation; a memory array (103) formed by arranging a plurality of memories each capable of storing data to be operated in the operation unit array; data transfer circuits (108, 701, 1101, 1501) each capable of changing the arrangement of data to be stored in the memory array; and a switch circuit (104) capable of switching data transfer paths between the memory array and the data transfer circuits. The semiconductor integrated circuit further includes a configuration data management unit (106) for managing the configuration data defining the logical behaviors in the operation unit array, the memory array, the data transfer circuit, and the switch circuit; and a state transition management unit (105) capable of controlling the switching of the configuration data relative to the operation unit array, the memory array, the data transfer circuit, and the switch circuit. The data transfer circuit includes a control circuit capable of autonomously sorting the data by determining the timing of the data sorting according to the setting included in the configuration data.

With the above described configuration, it is possible to incorporate a semiconductor integrated circuit, such as a highly independent flexible processor, into a system. In other words, the data rearrangement is possible in a semiconductor integrated circuit, so that the semiconductor integrated circuit can be integrated into a system when taking into account the data transfer equivalent to the existing dedicated circuit. As a result, the difficulty of the whole system design decreases. Further, in relation to the program running on the semiconductor integrated circuit, the dependency on the CPU, DMAC and the like is reduced. As a result, the availability of the flexible processor increases for changing the system configuration and the like.

[2] The semiconductor integrated circuit is coupled to a system bus (109), in which the data transfer circuit can be configured to autonomously change the data loaded through the system bus (109).

[3] The switch circuit can be a crossbar switch capable of switching the data transfer paths.

[4] The data transfer circuit can be configured to include a data processing circuit (403) for performing data transfer, and a data transfer control circuit (401) for causing the data processing circuit to start the data transfer when a configuration data switching instruction is made by the configuration data management unit. At this time, the data processing circuit can be configured to include a data input/output control circuit (404) for generating a data source address and a data destination address based on the configuration data transmitted from the configuration data management unit, as well as a data change circuit (405) for transferring the data corresponding to the data source address to a destination corresponding to the data destination address.

[5] The data transfer control circuit can be configured to determine whether an error occurs during the data transfer in the data processing circuit, and when an error occurs, stopping the data transfer in the data processing circuit to make an interrupt request.

[6] The data transfer circuit can be configured to include the data processing circuit (403) for performing data transfer, and a sequential data transfer control circuit (801) capable of controlling the data transfer in the data processing circuit. The sequential data transfer control circuit can be configured to include a table (802) capable of storing a plurality of configuration data transmitted from the configuration data management unit, thereby sequentially controlling the data transfers in the data processing circuit by sequentially reading the configuration data from the table.

[7] The data transfer circuit can be configured to include a data compress/decompress unit (1203) capable of performing data compress and decompress processings, and include a data compress/decompress and transfer control circuit (1201) capable of controlling the behavior of the data compress/decompress unit. At this time, the data compress/decompress and transfer control circuit can be configured to include a register (1202) capable of storing a plurality of configuration data transmitted from the configuration data management unit, thereby controlling the data compress or decompress processing in the data compress/decompress unit based on the configuration data stored in the register, and controlling the transfer of the data subjected to the data compress or decompress processing.

[8] The data transfer circuit can be configured to include a stream data processing circuit (1603) capable of transferring stream data, and a stream data transfer control circuit (1601) capable of controlling the data transfer in the stream data processing circuit. The stream data transfer control circuit can be configured to include a register (1602) capable of storing a plurality of configuration data transmitted from the configuration data management unit, thereby controlling the data transfer in the stream data processing circuit based on the configuration data stored in the register.

### 2. Description of the Embodiments

Next, the embodiments will be described further in detail.

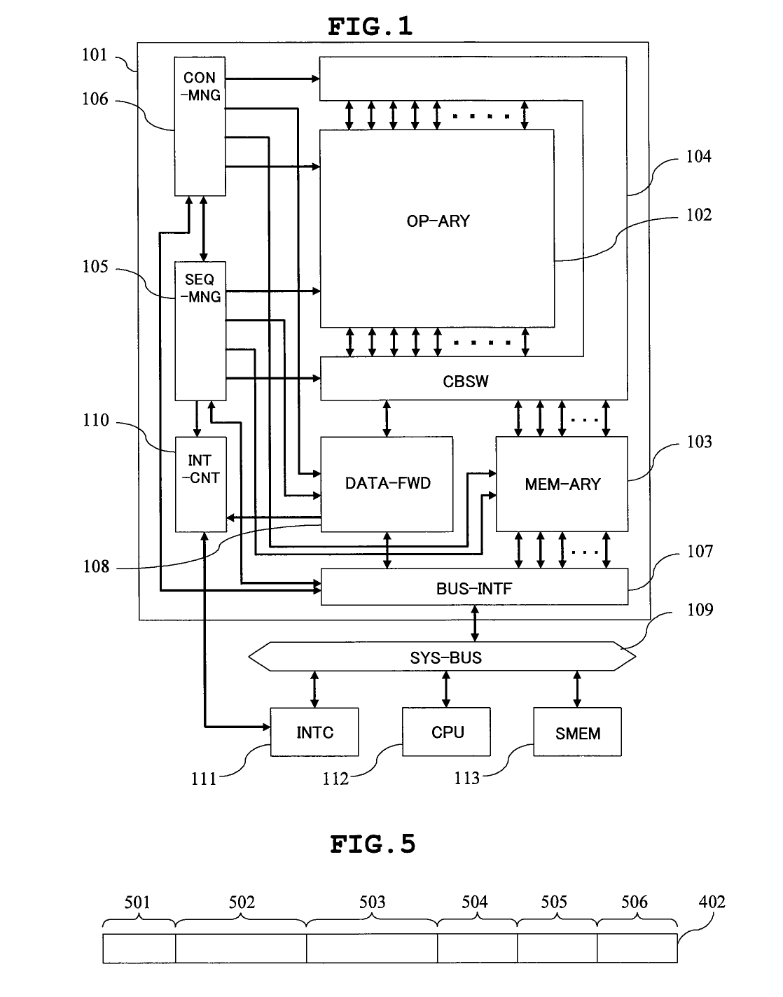

FIG. 1 shows a system LSI including a flexible processor which is an example of a semiconductor integrated circuit according to the present invention. The system LSI shown in FIG. 1 is formed over one semiconductor substrate such as a single crystal silicon substrate by well known semiconductor manufacturing technology.

Reference numeral 101 denotes a flexible processor. The flexible processor 101 allows instant switching of functions. Reference numeral 102 denotes an operation unit array (OP-ARY). The operation unit array 102 is formed by arranging a plurality of operation units in a matrix array each capable of performing a predetermined operation. The coupling relationship of the operation units can be changed according to the configuration data defining the logical behavior of the circuit. Reference numeral 103 denotes a built-in memory array (MEM-ARY). The built-in memory array 103 includes a plurality of load/store interfaces and memory banks. The data to be operated in the operation unit array 102 can be stored in the memory banks. Reference numeral 108 denotes a data transfer unit (DATA-FWD). The data transfer unit 108 controls the data transfer. Further, the data transfer unit 108 has a function for changing the arrangement of the data to be stored in the built-in memory array 103 according to the setting included in the configuration data. Reference numeral 104 denotes a crossbar switch (CBSW). The crossbar switch 104 can couple together the operation unit array 102, the built-in memory array 103, and the data transfer unit 108 according to the configuration data. Reference numeral 105 denotes a sequence manager (SEQ-MNG). The sequence manager 105 detects the switching timing of the configuration data, and issues a configuration data switching instruction to the operation unit array 102, the built-in memory array 103, the crossbar switch 104, and the data transfer unit 108. Reference numeral 106 denotes a configuration manager. The configuration manager 106 transfers the configuration data to be used for switching the configuration data in response to the instruction of the configuration manager 105, to the operation unit array 102, the built-in memory array 103, the crossbar switch 104, and the data transfer unit 108. Reference numeral 107 denotes a bus interface (BUS-INTF). The bus interface 107 couples the inside and outside of the flexible processor to transfer the operation data, operation results, and configuration data or other information. Reference numeral 110 denotes an interrupt request control circuit (INT-CNT). The interrupt request control circuit 110 notifies of an interrupt factor occurred in the flexible processor 101 as an interrupt request. Reference numeral 109 denotes a system bus (SYS-BUS). Through the system bus 109, the bus interface 107 in the flexible processor 101, an interrupt controller 111, a CPU 112, and a memory (SMEN) 113 are coupled to each other so as to be able to exchange signals. Reference numeral 111 denotes the interrupt controller (INTC). The interrupt controller 111 controls all the interrupt requests. Reference numeral 112 denotes the CPU. The CPU 112 controls the behaviors of the whole system. The program and data are stored in the memory 113.

Incidentally, the semiconductor integrated circuit shown in FIG. 1 is assumed to be configured as a single LSI. However, the bus interface 107, system bus 109, interrupt controller 111, CPU 112, and memory 113 may not necessarily be configured over the same LSI, and may exist over another LSI coupled through an external pin or other coupling means.

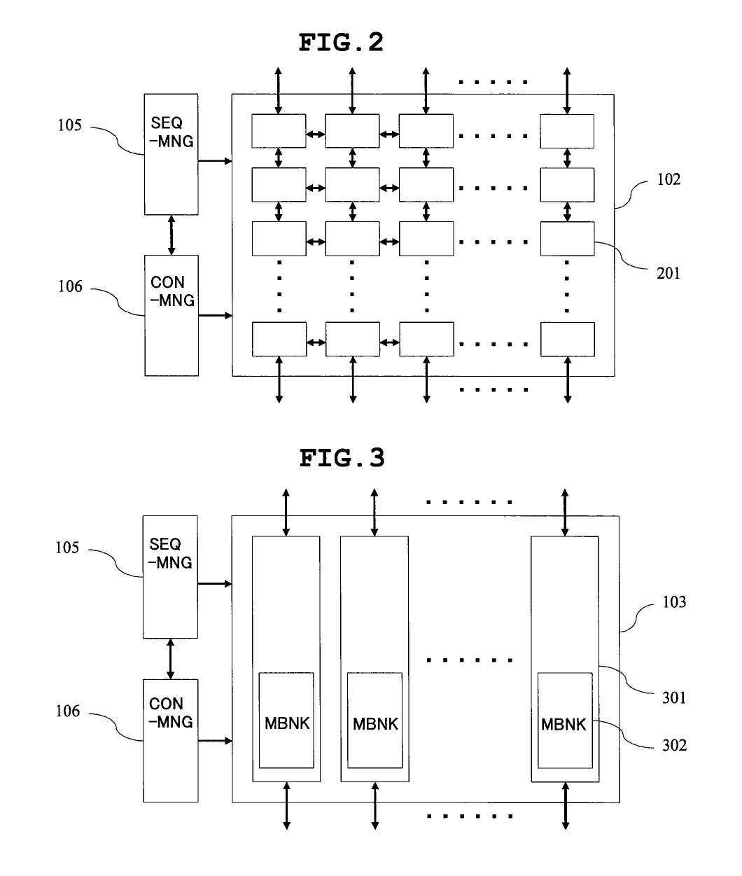

FIG. 2 shows an example of configuration of the operation unit array 102.

The operation unit array 102 includes the operation units 201 arranged in a matrix array. The operation unit 201 receives the configuration data from the configuration manager 106, and changes the operation contents and the coupling with the other operation units 201, in response to a switching instruction from the sequence manager 106. Incidentally, in FIG. 2, the operation unit array 102 is configured with only one type of the operation units 201, but an arbitrary number of operation units of different types may be mixed. Further, in FIG. 2, only the adjacent operation units 201 are coupled to each other, but the present invention is not limited to such a coupling method.

FIG. 3 shows an example of configuration of the built-in array 103.

The built-in memory array 103 includes the load/store interfaces 301 and memory banks (MBNK) 302. Each access to the memory banks (302) is controlled by each of the load/store interfaces 301. The load/store interface receives the configuration data from the configuration manager 106, and changes the processings such as load and store, as well as the transfer size in response to the switching instruction from the sequence manager 106. Incidentally, in FIG. 3, the memory bank 302 corresponds to the load/store interface 301 on a one to one basis, but a plurality of memory banks 302 may be mounted. Further, not only a single port but also a plurality of ports may be mounted to the memory bank 302. When a load/store is performed from the system bus to the memory bank 302, the bus interface 107 selects an appropriate load/store interface from the address to exchange the data. When a load/store is performed from the operation unit array 102 to the memory bank 302, an appropriate configuration data is set to the crossbar switch 104 to couple an arbitrary operation unit 201 having a port that can be coupled to the outside of the operation unit array 102, through the crossbar switch 104.

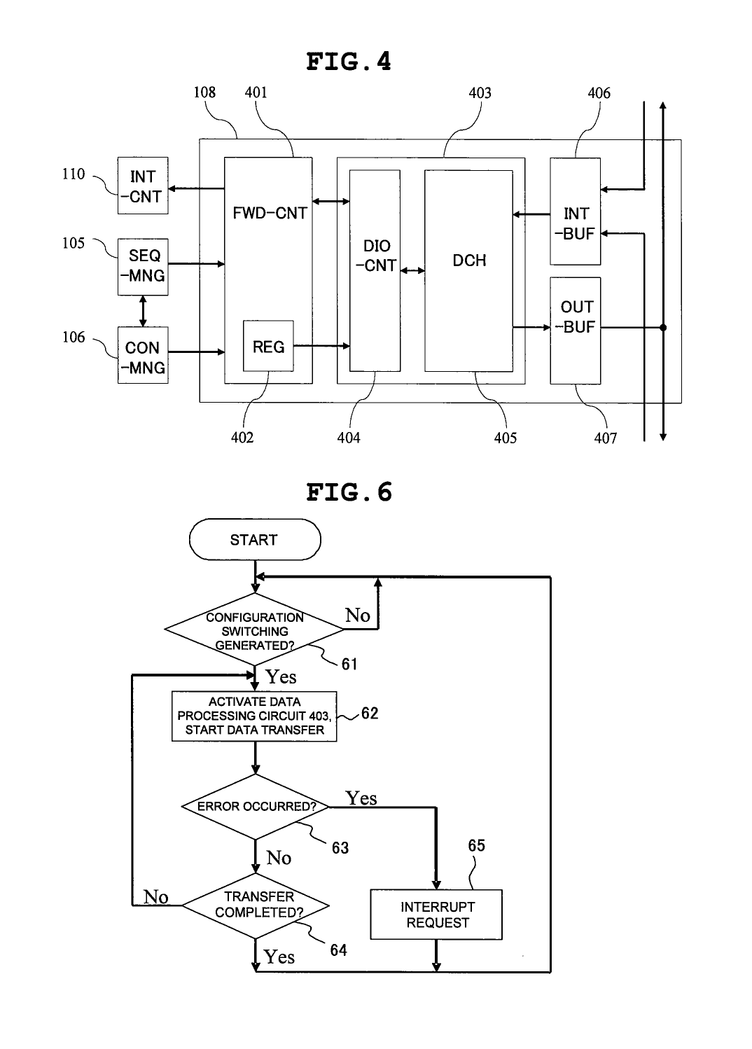

FIG. 4 shows an example of configuration of the data transfer unit 108.

The data transfer unit 108 includes a data transfer control circuit (FWD-CNT) 401, a data processing circuit 403, an input data buffer (IN-BUF) 406, and an output data buffer (OUT-BUF) 407. The data transfer control circuit 401 includes a configuration data register (REG) 402 to store the configuration data from the configuration manager 106. The data transfer control circuit 401 receives a switching instruction from the sequence manager 105, and instructs the data processing circuit 403 to perform the processing based on the configuration data stored in the configuration data register 402. Further, the data transfer control circuit 401 detects an error occurred in the data transfer unit 108, and notifies the interrupt request control circuit 110. The data processing circuit 403 includes a data input/output control circuit 404 and a data change circuit (DCH) 405. The data input/output control circuit 404 receives a processing start instruction from the data transfer control circuit 401, and generates a transfer start request as well as additional data such as a destination address based on the configuration data stored in the configuration data register 402. The transfer start request is transmitted to the load/store interface 301 coupled to the crossbar switch according to the configuration data in the built-in memory array 103 through the crossbar switch (104) having specific configuration data. Alternatively, the transfer start request is directly transmitted to the bus interface 107. Upon receiving the request, the load/store interface 301 reads the data from the memory bank 302, and transmits the data to the input data buffer 406 of the data transfer unit 108. When the bus interface 107 receives the request, the request is transmitted to the system bus 109. Then, the data corresponding to the request is transferred to the input data buffer 406 of the data transfer unit 108. The data accumulated in the input data buffer 406 are stored in the output data buffer 407 through an operation in the data change circuit 405 based on the configuration data. Subsequently, based on the configuration data stored in the configuration data register 402, the data input/output control circuit 404 generates again a transfer start request as well as additional data such as a destination address of the data stored in the output data buffer 407. The request is transmitted to the load/store interface 301 or the bus interface 107. Finally, the request is transferred to any of the memory banks 302 or to the outside of the flexible processor 101 through the system bus 109.

FIG. 5 shows an example of the configuration data to be stored in the configuration data register 402.

The configuration data register 402 stores an operation code 501, a source address 502, a destination address 503, a source address stride width 504, a destination address stride width 505, and a transfer count 506. Incidentally, the order of data storage may be changed. The operation code 501 includes the command that indicates the processing to be performed in the data processing circuit 403. This command needs only to uniquely identify the transfer processing, and may be appropriately defined as the number of types of the transfer processing increases. The source address 502 includes the address at which the data transfer unit 108 starts the transfer. The destination address 503 includes the address to which the data transfer unit 108 transmits the data. The source stride width 504 and the destination stride width 505 include the address volume to be added or subtracted each time the transfer is performed to the destination address 502 and to the source address 503, respectively. The transfer count 506 includes the number of times to perform the processing specified by the operation code 501.

Next, the behaviors of the data transfer control circuit 401 and the data processing circuit 403 will be described with reference to the flowchart shown in FIG. 6.

When the processing of the flexible processor 101 is started, a determination is made in the data transfer control circuit 401 whether the configuration manager 106 generates a configuration switching instruction (Step 61). In this determination, when it is determined that the configuration manager 106 generates a configuration switching instruction (Yes), the data transfer control circuit 401 activates the data processing circuit 403 to start data transfer according to the configuration data stored in the configuration data register 402 (Step 62). During the transfer, a determination is made in the data transfer control circuit 401 whether an error factor inhibiting the data transfer occurs, such as transfer to an incorrect address, abnormality in the configuration data, access competition to the memory, or generation of a configuration data switching instruction before completion of the data transfer (Step 63). In this determination, when it is determined that no error factor occurs (No), a determination is made whether the data transfer is completed (Step 64). In the determination of Step 63, when it is determined that an error factor occurs (Yes), the data transfer control circuit 401 stops the data transfer in the data processing circuit 403, notifies the interrupt request control circuit 110 of an interrupt request, and goes to a state of waiting for a configuration data switching instruction (Step 65). In this case, the interrupt request is transmitted from the interrupt request control circuit 110 to the interrupt controller 111, and then a predetermined interrupt processing is performed in the CPU 112. When it is determined that no error factor occurs (No) in the determination of Step 63, a determination is made whether the data transfer is completed (Step 64). In this determination, when it is determined that the data transfer is not completed (No), the processing is moved to the data transfer processing of Step 62. When it is determined that the transfer is completed (Yes) in the determination of Step 64, the processing is returned to the determination of Step 61.

Incidentally, when the CPU 112 is not mounted in the same LSI in which the flexible processor 101 is mounted, a register for storing the error notification from the data transfer control circuit 401 may be provided so that the data stored in the register can be confirmed from the outside by the CPU. Alternatively, it may be possible to monitor the error notification from an external pin of the LSI in which the flexible processor 101 is mounted.

According to the above example, the following operational effects can be obtained.

With the flexible processor 101 having the above described configuration, it is possible to automatically perform the data rearrangement among the memory banks 302 in the built-in memory array 103, or the data transfer between the memory bank 302 in the built-in memory array 103 and the outside of the flexible processor 101, synchronously with the configuration switching generation, without using the CPU and DMAC. Because the data rearrangement is possible in the flexible processor 101, the integration into the system can be enabled when taking into account the data transfer equivalent to the existing dedicated circuit. As a result, the difficulty of the whole system design decreases. Further, in relation to the program running on the semiconductor integrated circuit, the dependency to the CPU, DMAC and the like decreases. As a result, the availability of the flexible processor increases for changing the system configuration and the like.

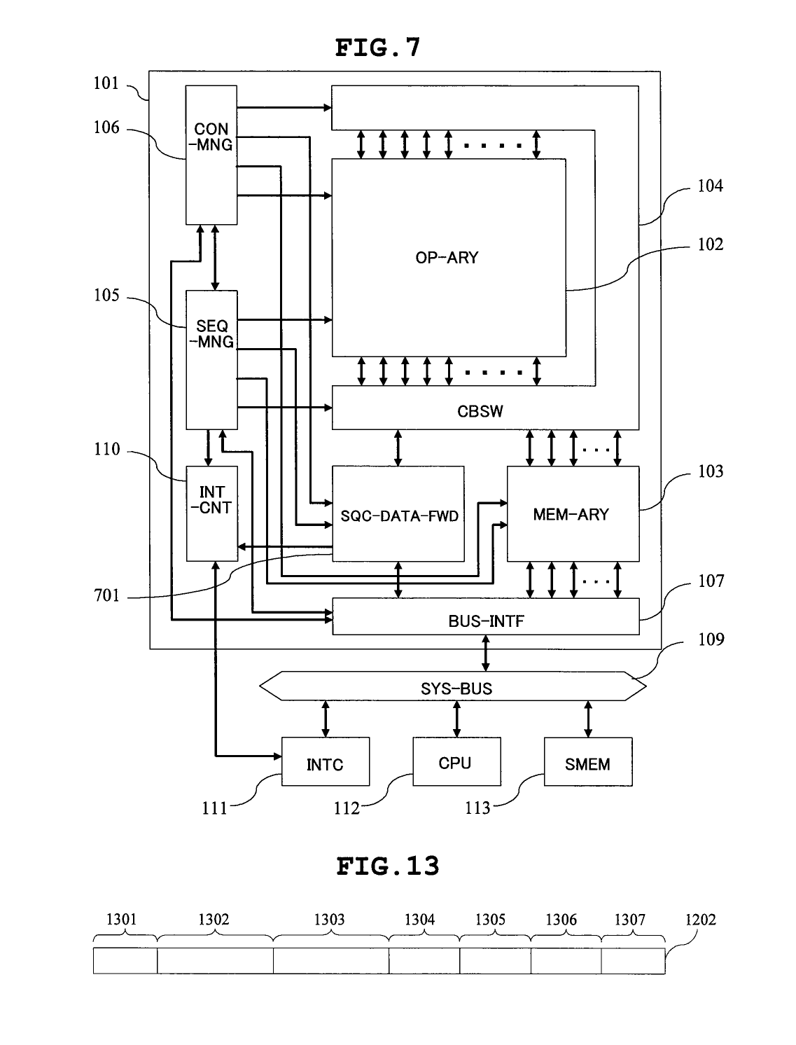

FIG. 7 shows another example of configuration of the system LSI including a flexible processor which is an example of the semiconductor integrated circuit according to the present invention.

The system LSI shown in FIG. 7 is largely different from that shown in FIG. 1 in the point that a sequential data transfer unit (SQC-DATA-FWD) 701 is provided to sequentially perform the data rearrangements in the built-in memory array 103, in place of the data transfer unit 108. The operation unit array 102, the built-in memory array 103, and the sequential data transfer unit 701 are coupled to each other through the crossbar switch 104 so as to be able to exchange data. The sequence manager 105 issues a configuration data switching instruction to the built-in memory array 103, the crossbar switch 104, and the sequential data transfer unit 701. The configuration manager 106 transfers the configuration data to be used for switching the configuration data in response to the instruction of the sequence manager 105, to the operation unit array 102, the built-in memory array 103, the crossbar switch 104, and the sequential data transfer unit 701.

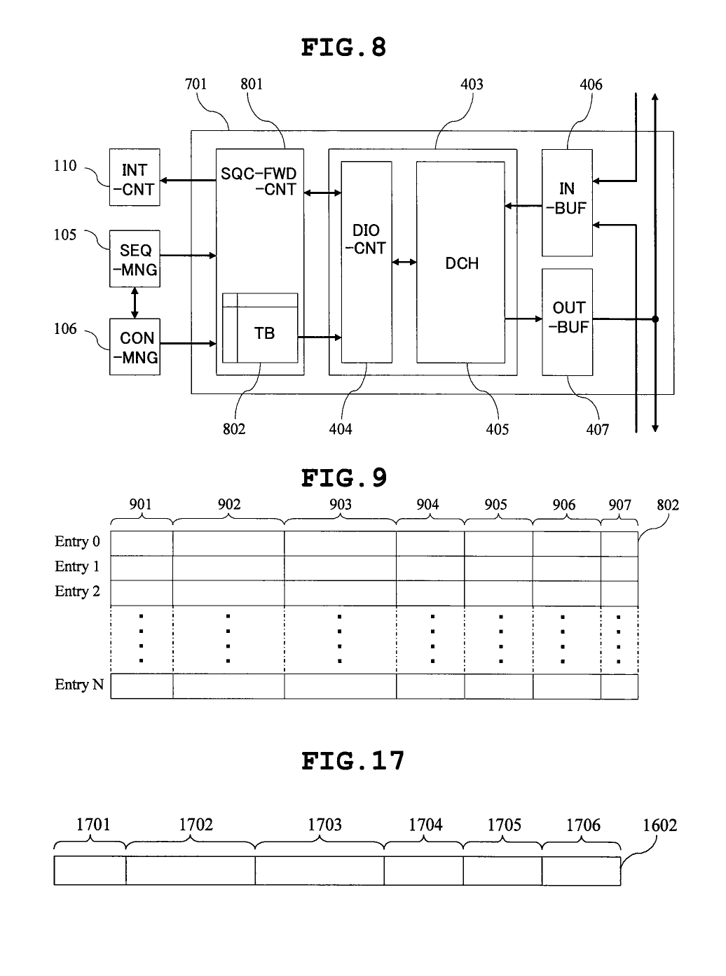

FIG. 8 shows an example of configuration of the sequential data transfer unit 701.

As shown in FIG. 8, the sequential data transfer unit 701 includes a sequential data transfer control circuit (SQC-FWD-CNT) 801, the data processing circuit 403, the input data buffer 406, and the output data buffer 407. The sequential data transfer control circuit 801 includes a configuration data table (TB) 802 to store a plurality of configuration data transmitted from the configuration manager 106. Further, the sequential data transfer control circuit 801 detects an error occurred in the sequential data transfer unit 701, and notifies the interrupt request control circuit 110.

FIG. 9 shows an example of configuration of the configuration data table 802.

The configuration data table 802 stores the configuration data into the table as an arbitrary number of entries. Each entry has an operation code field 901, a source address field 902, a destination address field 903, a source address stride width field 904, a destination address stride width field 905, a transfer count field 906, and a next operation field 907. Incidentally, the order of data storage may be changed. The operation code field 901 of each entry stores the command that indicates the processing to be performed in the data processing circuit 403. Incidentally, this command needs only to uniquely identify the transfer processing, and may be appropriately defined as the number of types of the transfer processing increases. The source address field 902 stores the address at which the sequential data transfer unit 701 starts the transfer. The destination address field 903 stores the address to which the sequential data transfer unit 701 transmits the data. The source stride width field 904 and destination stride width field 905 of each entry store the address volume to be added or subtracted each time the transfer is performed to the source address field 902 and destination address field 903 of the same entry, respectively. The transfer count field 906 of each entry stores the number of times to perform the processing specified by the operation code field 901 of the same entry. The next operation field 907 of each entry stores the start entry number or the end code, after completion of the operation of the relevant entry. Incidentally, at least one end code needs to be defined, which may be arbitrary unless it is identical to the entry number.

Upon receiving the switching instruction from the sequence manager 105, the sequential data transfer control circuit 801 having the above described configuration reads an appropriate entry from the entry group stored in the configuration data table 802, and instructs the data processing circuit 403 to perform the processing. After the data transfer is completed by the data processing circuit 403, the sequential data transfer control circuit 801 stops the operation when the end code is stored in the next operation field 907 of the relevant entry, and goes to a state of waiting for a switching instruction from the sequence manager 105. When the entry number is specified, the sequential data transfer control circuit 801 reads the specified entry from the entry group stored in the configuration data table 802, and instructs again the data processing circuit 403 to start a processing.

The data processing circuit 403 shown in FIG. 8 includes the data input/output control circuit (DIO-CNT) 404 and the data change circuit (DCH) 405. The data input/output control circuit 404 receives the processing start instruction from the sequential data transfer control circuit 801, reads an appropriate entry from the entry group stored in the configuration data table 802, and generates a transfer start request as well as additional data such as a destination address based on the entry data. The transfer start request is transmitted to the load/store interface 301 coupled to the crossbar switch 104 according to the configuration data in the built-in memory array 103 through the crossbar switch 104 having specific configuration data. Alternatively, the transfer start request is directly transmitted to the bus interface 107. Upon receiving the request, the load/store interface 301 reads the data from the memory bank 302, and transmits the data to the input data buffer 406 of the sequential data transfer unit 701. When the bus interface 107 receives the request, the request is transmitted to the system bus 109. Then, the data corresponding to the request is transferred to the input data buffer 406 of the sequential data transfer unit 701. The data accumulated in the input data buffer 406 are processed in the data change circuit 405 based on the entry data, and are stored in the output data buffer 407. Subsequently, based on the entry data, the data input/output control circuit 404 generates again a transfer start request as well as additional data such as a destination address of the data stored in the output data buffer 407. The request is transmitted to the load/store interface 301 or to the bus interface 107. Finally, the request is transferred to any of the memory banks 302 or to the outside of the flexible processor 101 through the system bus 109.

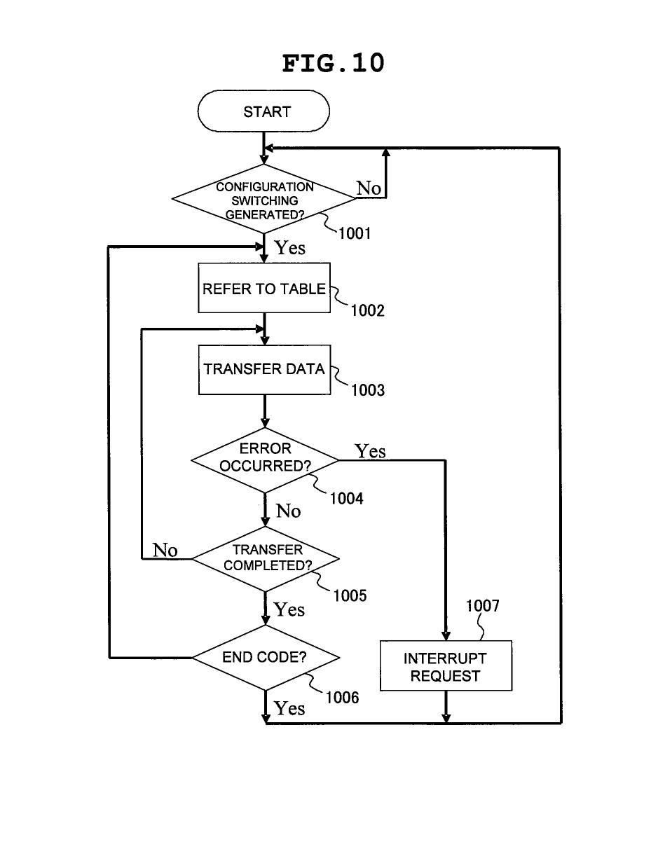

Next, the behaviors of the sequential data transfer control circuit 801 and the data processing circuit 403 will be described with reference to the flowchart shown in FIG. 10.

When the processing of the flexible processor 101 is started, a determination is made in the data transfer control circuit 801 whether the configuration manager 106 generates a configuration switching instruction (Step 1001). In this determination, when it is determined that the configuration manager 106 generates a configuration switching instruction (Yes), the sequential data transfer control circuit 801 reads the entry specified by the configuration data by referring to the configuration data table 802 (Step 1002), and activates the data processing circuit 403 to start data transfer according to the entry data (Step 1003). Then, a determination is made whether an error occurs (Step 1004). During the data transfer performed according to the entry data, when there is no error factor inhibiting the data transfer, such as transfer to an incorrect address, abnormality in the configuration data, access competition to the memory, or generation of a configuration switching instruction before completion of the data transfer, then the data transfer is completed. When it is determined that an error occurs (Yes) in the determination of Step 1004, the sequential data transfer control circuit 801 stops the transfer, notifies the interrupt request control circuit 110 (Step 1007), and goes to a state of waiting for a configuration switching instruction. When it is determined that no error occurs (No) in Step 1004, a determination is made whether the transfer is completed (Step 1005). When the transfer is completed without any error occurring, the next operation field 907 of the entry is checked. When an end code is stored in the table, the sequential data transfer control circuit 801 stops the operation and goes to a state of waiting for a switching instruction from the sequence manager 105. When an entry number is specified in the next operation field 907 of the entry, the sequential data transfer control circuit 801 reads the specified entry from the entry group stored in the configuration data table 802, and instructs again the data processing circuit 403 to start a processing.

With the above described configuration, by using the configuration data for the sequential data transfer unit 701, it is possible to perform the data rearrangement among the memory banks 302 in the built-in memory array 103, or to perform the data transfer between the memory bank 302 in the built-in memory array 103 and an address outside the flexible processor 101 in a plurality of combinations, synchronously with the configuration switch generation and automatically without using the CPU and DMAC.

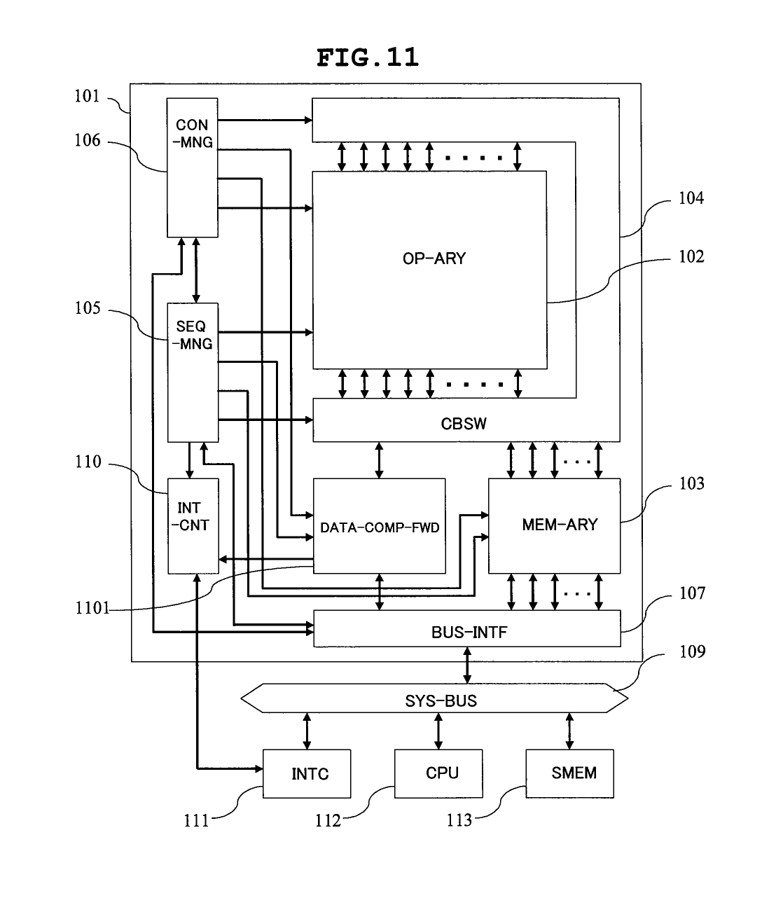

FIG. 11 shows an example of configuration of the system LSI including a flexible processor which is an example of the semiconductor integrated circuit according to the present invention.

The system LSI shown in FIG. 11 is largely different from that shown in FIG. 1 in the point that a data compress and transfer unit (DATA-COMP-FWD) 1101 is provided to compress and rearrange the data in the built-in memory array 103, in place of the data transfer unit 108. The operation unit array 102, the built-in memory array 103, and the data compress and transfer unit 1101 are coupled to each other through the crossbar switch 104 so as to be able to exchange the data. The sequence manager 105 issues a configuration data switching instruction to the built-in memory array 103, the crossbar switch 104, and the data compress and transfer unit 1101. The configuration manager 106 transfers the configuration data to be used for switching the configuration data in response to the instruction of the sequence manager 105, to the operation unit array 102, the built-in memory array 103, the crossbar switch 104, and the data compress and transfer unit 1101.

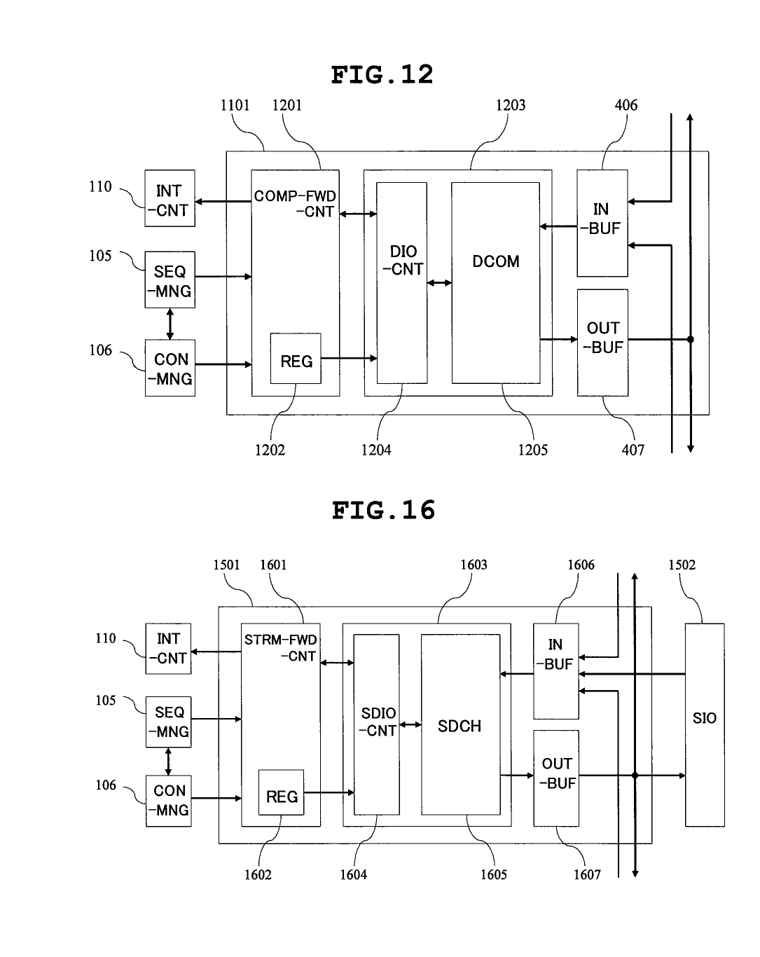

FIG. 12 shows an example of configuration of the data compress and transfer unit 1101.

The data compress and transfer unit 1101 includes a data compress/decompress and transfer control circuit (COMP-FWD-CNT) 1201, a data compress/decompress unit 1203, the input data buffer (IN-BUF) 406, and the output data buffer (OUT-BUF) 407. The data compress/decompress and transfer control circuit 1201 includes a configuration data register (REG) 1202 to store the configuration data from the configuration manager 106. The data compress/decompress and transfer control circuit 1201 receives a switching instruction from the sequence manager 105, and instructs the data compress/decompress unit 1203 to perform the processing based on the configuration data stored in the configuration data register 1202. Further, the data compress/decompress and transfer control circuit 1201 detects an error occurred in the data compress and transfer unit 1101, and notifies the interrupt request control circuit 110. The data compress/decompress unit 1203 includes a data input/output control circuit (DIO-CNT) 1204 and a data compress/decompress circuit (DCOM) 1205. The data input/output control circuit 1204 receives a processing start instruction from the data compress/decompress and transfer control circuit 1201, and generates a transfer start request as well as additional data such as a destination address, based on the configuration data stored in the configuration data register 1202. The transfer start request is transmitted to the load/store interface 301 coupled to the crossbar switch according to the configuration data in the built-in memory array 103 through the crossbar switch having specific configuration data. Alternatively, the request is directly transmitted to the bus interface 107. Upon receiving the request, the load/store interface 301 reads the data from the memory bank 302, and transmits the data to the input data buffer 406 of the data compress and transfer unit 1101. When the bus interface 107 receives the request, the request is transmitted to the system bus 109. Then, the data corresponding to the request is transferred to the input data buffer 406 of the data compress and transfer unit 1101. The data accumulated in the input data buffer 406 are compressed or decompressed in the data compress/decompress circuit 1205 based on the configuration data, and are stored in the output data buffer 407. Subsequently, based on the configuration data stored in the configuration data register 1202, the data input/output control circuit 1204 generates again a transfer start request as well as additional data such as a destination address of the data stored in the output data buffer 407. The request is transmitted to the load/store interface 301 or the bus interface 107. Finally, the request is transferred to any of the memory banks 302 or to the outside of the flexible processor 101 through the system bus 109.

FIG. 13 shows an example of the configuration data to be stored in the configuration data register 1202.

The configuration data register 1202 stores a compress/decompress and transfer command 1301, a source address 1302, a destination address 1303, a source address stride width 1304, a destination address stride width 1305, a transfer count 1306, and a compress/decompress type 1307. Incidentally, the order of data storage is arbitrary. The compress/decompress and transfer command 1301 stores the command that indicates the processing to be performed in the data compress/decompress unit 1203. Incidentally, the command needs only to uniquely identify the processing such as transfer and compress/decompress, or the combination of the both, and may be appropriately defined as the number of types of the compress/decompress and transfer processing increases. The source address 1302 includes the address at which the data compress and transfer unit 1101 starts the compress/decompress and transfer processing. The destination address 1303 includes the address to which the data compress and transfer unit 1101 transmits the data. The source stride width 1304 and the destination stride width 1305 are updated by the address volume to be added or subtracted each time the transfer is performed to the source address 1302 and the destination address 1303, respectively. The transfer count 1306 is updated by the number of times to perform the processing specified by the compress/decompress and transfer command 1301. The compress/decompress type 1307 includes the compress/decompress algorithm data to be used in the data compress/decompress unit 1203. Incidentally, the compress/decompress type that can be specified in the compress/decompress 1307 is only the compress/decompress algorithm that can be processed in the data compress/decompress unit 1203. Further, the compress/decompress type 1307 can be included in the compress/decompress and transfer command 1301, and is not necessarily separated therefrom. However, the compress/decompress type 1307 is preferably separated, with consideration of the decoding time of the compress/decompress and transfer command 1301.

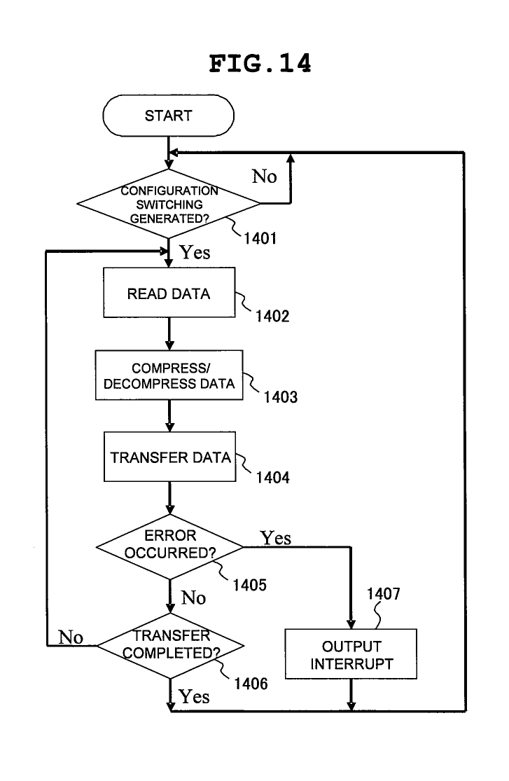

Next, the behaviors of the data compress/decompress and the transfer control circuit 1201 and the data compress/decompress unit 1203 will be described with reference to the flowchart shown in FIG. 14.

When the processing of the flexible processor 101 is started, the data compress/decompress and transfer control circuit 1201 waits for a configuration switching instruction generated by the configuration manager 106 (Step 1401). When the configuration switching instruction is generated (Yes), the data compress/decompress and transfer control circuit 1201 reads the data according to the configuration data stored in the configuration data register 1202 (Step 1402). Upon completion of the reading, the data compress/decompress and transfer control circuit 1201 activates the data compress/decompress unit 1203 to start a data compress/decompress processing according to the configuration data stored in the configuration data register 1202 (Step 1403). After completion of the data compress/decompress, the data compress/decompress unit 1203 transfers (writes) the data according to the configuration data stored in the configuration data register 1202 (Step 1404). During the data compression/decompression and transfer (reading/writing), a determination is made whether an error occurs to inhibit the data compression/decompression and transfer, such as a case in which a compress/decompress algorithm unavailable for the data compress/decompress unit 1203 is specified, transfer to an incorrect address, abnormality of the configuration data, access competition to the memory, or generation of a configuration switching instruction before completion of the data transfer (Step 1405). When there is no error factor detected, the data compression/decompression and transfer are repeated until the processing is completed (Step 1406). When it is determined that an error occurs (Yes) in the determination of Step 1404, the data compress/decompress and transfer control circuit 1201 stops the data compression/decompression and transfer, notifies the interrupt request control circuit 110 (Step 1407), and goes to a state of waiting for a configuration switching instruction.

As described above, by using the configuration data for the data compress and transfer unit 1101, it is possible to perform the data compress and transfer among the memory banks 302 in the built-in memory array 103, or complex data transfer such as rearrangement with decompression, or data compression and transfer between the outside of the flexible processor 101 and the memory bank 302 in the built-in memory array 103, synchronously with the configuration switch generation and automatically without using the CPU and DMAC.

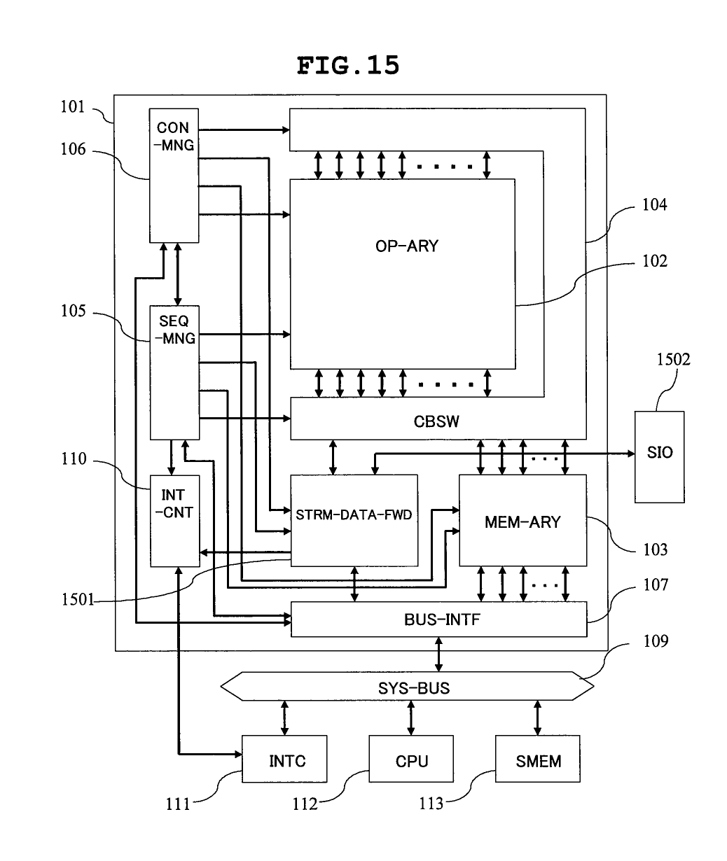

FIG. 15 shows an example of configuration of the system LSI including a flexible processor which is an example of the semiconductor integrated circuit according to the present invention.

The system LSI shown in FIG. 15 is largely different from that shown in FIG. 1 in the point that a stream input/output unit (SIO) 1502 for allowing input/output of stream data, such as video, sound, and animation, is provided in the outside of the flexible processor 101, and that a stream data transfer unit (STRM-DATA-FWD) 1501 for allowing data transfer between the stream input/output unit 1502 and the built-in memory array 103 is provided in place of the data transfer unit 108. The operation unit array 102, the built-in memory array 103, and the stream data transfer unit 1501 are coupled to each other through the crossbar switch 104 so as to be able to exchange the stream data. The sequence manager 105 issues a configuration data switching instruction to the built-in memory array 103, the crossbar switch 104, and the stream data transfer unit 1501. The configuration manager 106 transfers the configuration data to be used for switching the configuration data in response to the instruction of the sequence manager 105, to the operation unit array 102, the built-in memory array 103, the crossbar switch 104, and the stream data transfer unit 1501.

FIG. 16 shows an example of configuration of the stream data transfer unit 1501.

The stream data transfer unit 1501 includes a stream data transfer control circuit (STRM-FWD-CNT) 1601, a stream data processing circuit 1603, an input data buffer (IN-BUF) 1606, and an output data buffer (OUT-BUF) 1607. The stream data transfer control circuit 1601 includes a configuration data register (REG) 1602 to store the configuration data from the configuration manager 106. The stream data transfer control circuit 1601 receives a switching instruction from the sequence manager 105, and instructs the stream data processing circuit 1603 to perform the processing based on the configuration data stored in the configuration data register 1602. Further, the stream data transfer control circuit 1601 detects an error occurred in the stream data transfer unit 1501, and notifies the interrupt request control circuit 110. The stream data processing circuit 1603 includes a stream data input/output control circuit (SDIO-CNT) 1604 and a stream data change circuit (SDCH) 1605. The stream data input/output control circuit 1604 receives a processing start instruction from the stream data transfer control circuit 1601, and generates a transfer start request as well as additional data such as a destination address, based on the configuration data stored in the configuration data register 1602. The transfer start request is transmitted to the load/store interface 301 coupled to the crossbar switch according to the configuration data in the built-in memory array 103 through the crossbar switch 104 having specific configuration data. Alternatively, the transfer start request is directly transmitted to the bus interface 107 or the stream input/output unit 1502. Upon receiving the request, the load/store interface 301 reads the data from the memory bank 302, and transmits the data to the input data buffer 1606 of the stream data transfer unit 1501. When the bus interface 107 receives the request, the request is transmitted to the system bus 109. Then, the data corresponding to the request is transferred to the input data buffer 1606 of the stream data transfer unit 1501. Similarly, when the stream input/output unit receives the request, the data corresponding to the request is transferred to the input data buffer 1606 of the stream data transfer unit 1501. The data accumulated in the input data buffer 1606 are processed in the stream data change circuit 1605 based on the configuration data, and are stored in the output data buffer 1607. Subsequently, based on the configuration data stored in the configuration data register 1602, the stream data input/output control circuit 1604 generates again a transfer start request as well as additional data such as a destination address of the data stored in the output data buffer 1607. The request is transmitted to the load/store interface 301, or to the bus interface 107, or to the stream input/output unit 1502. Finally, the request is transferred to any of the memory banks 302, or to the system bus 109, or to the outside of the flexible processor 101 through the stream input/output unit.

FIG. 17 shows the configuration data to be stored in the configuration data register 1602.

The configuration data register 1602 stores an operation code 1701, a source address 1702, a destination address 1703, a source address stride width 1704, a destination address stride width 1705, and a transfer count 1706. Incidentally, the order of data storage may be changed. The operation code 1701 includes the command that indicates the processing to be performed in the stream data processing circuit 1603. Incidentally, the command needs only to uniquely identify the transfer processing, and may be appropriately defined as the number of types of the transfer processing increases. The source address 1702 includes the address at which the stream data transfer unit 1501 starts the transfer. The destination address 1703 includes the address to which the stream data transfer unit 1501 transmits the data. The source stride width 1704 and the destination stride width 1705 include the address volume to be added or subtracted each time the transfer is performed to the destination address 1702 and the source address 1703, respectively. The transfer count 1706 includes the number of times to perform the processing specified by the operation code 1701. Such configuration data is not referred to when the destination and source addresses and other data are not necessary, such as in the input/output of the stream data.

Incidentally, the stream input/output unit 1502 does not necessarily have such an input/output mechanism, and may only have an input or output configuration.

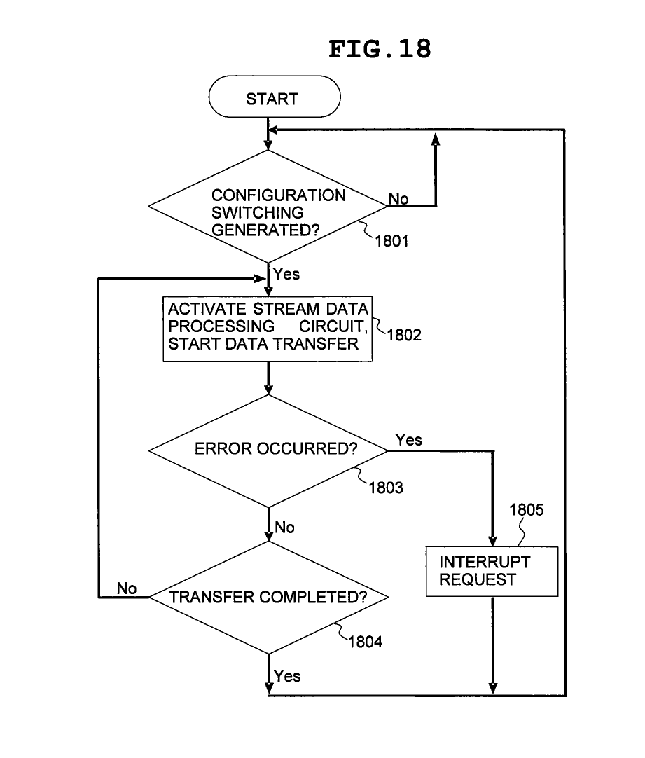

Next, the behaviors of the stream data transfer control circuit 1601 and the stream data processing circuit 1603 will be described with reference to the flowchart shown in FIG. 18.

When the processing of the flexible processor 101 is started, the stream data transfer control circuit 1601 waits for a configuration switching instruction generated by the configuration manager 106 (Step 1801). When a configuration switching instruction is generated (Yes), the stream data transfer control circuit 1601 activates the stream data processing circuit 1603 to start data transfer according to the configuration data stored in the configuration data register 1602 (Step 1802). During the transfer, when there is no error factor inhibiting the data transfer, such as transfer to an incorrect address, abnormality in the configuration data, access competition to the memory, and generation of a configuration switching instruction before completion of the data transfer, a determination is made whether the data transfer is completed (Step 1804). When an error factor is detected in the determination of Step 1803, the stream data transfer control circuit 1601 stops the transfer, notifies the interrupt request control circuit 110 (Step 1805), and goes to a state of waiting for a configuration switching instruction.

With the above described configuration, by using the configuration data for the stream data transfer unit 1501, it is possible to perform data transfer between the stream input/output unit 1502 and the memory bank 302 in the built-in memory array 103, or to perform data transfer between the stream input/output unit 1502 and an address outside the flexible processor 101, synchronously with the configuration switch generation and automatically without using the CPU and DMAC.

The invention made by the present inventors has been concretely described based on the embodiments. However, it is needless to say that the present invention is not limited to the foregoing embodiments and various modifications and alterations can be made within the scope of the present invention.

For example, it is possible to change the configuration data register 1202 to a table reference type circuit like the configuration data table 802. In such a case, the compress/decompress and transfer processing can be performed sequentially.

Further, it is possible to use other circuits for data processing, such as, for example, an encryption circuit and an encoding circuit, in place of or in addition to the data compress/decompress and transfer circuit. In such a case, higher processing and transfer can be achieved. At this time, the configuration data of the configuration data register 1202 can also be enlarged to make the processing more flexible. In addition, the processing can be sequentially performed when the configuration data register 1202 is changed to a table reference type circuit like the configuration data table 802.

The foregoing description has focused on the case in which the invention made by the present inventors is applied to the flexible processor 101 belonging to the technical field which is the background of the invention. However, the present invention is not limited thereto, and is widely applicable to various semiconductor integrated circuits.

What is claimed is:

1. A semiconductor integrated circuit comprising:
an operation unit array formed by arranging a plurality of operation units each capable of performing a predetermined operation;
a memory array formed by arranging a plurality of memories each capable of storing data to be operated in the operation unit array;
a data transfer circuit capable of changing the arrangement of the data to be stored in the memory array;
a switch circuit for allowing the switching of the data transfer paths among the operation unit array, the memory array, and the data transfer circuit;
a configuration data management unit for managing configuration data defining the logical behaviors in the operation unit array, the memory array, the data transfer circuit, and the switch circuit; and
a state transition management unit capable of controlling the switching of the configuration data relative to the operation unit array, the memory array, the data transfer circuit, and the switch circuit,
wherein the data transfer circuit includes a control circuit capable of autonomously sorting data by determining the timing of the data sorting according to the setting included in the configuration data.

2. The semiconductor integrated circuit according to claim 1,
wherein the semiconductor integrated circuit is coupled to a system bus, and
wherein the data transfer circuit allows the autonomous change of the data loaded through the system bus.

3. The semiconductor integrated circuit according to claim 1,
wherein the switch circuit is a crossbar switch for allowing the switching of the data transfer paths.

4. The semiconductor integrated circuit according to claim 1,
wherein the data transfer circuit includes:
a data processing circuit for performing data transfer; and
a data transfer control circuit for causing the data processing circuit to start the data transfer when a configuration switching instruction is made by the configuration data management unit, and
wherein the data processing circuit includes:
a data input/output control circuit for generating a data source address and a data destination address, based on the configuration data transmitted from the configuration data management unit; and
a data change circuit for transferring data corresponding to the data source address, to a destination corresponding to the data destination address.

5. The semiconductor integrated circuit according to claim 4,
wherein the data transfer control circuit determines whether an error occurs during the data transfer in the data processing circuit, and when an error occurs, stops the data transfer in the data processing circuit to make an interrupt request.

6. The semiconductor integrated circuit according to claim 1,
wherein the data transfer circuit includes:
a data processing circuit for performing data transfer; and
a sequential data transfer control circuit capable of controlling the data transfer in the data processing circuit,
wherein the sequential data transfer control circuit includes a table capable of storing a plurality of configuration data transmitted from the configuration data management unit, and can sequentially control the data transfers in the data processing circuit by sequentially reading the configuration data from the table.

7. The semiconductor integrated circuit according to claim 1,
wherein the data transfer circuit includes:
a data compress/decompress unit capable of performing data compress and decompress processings; and
a data compress/decompress and transfer control circuit capable of controlling the behavior of the data compress/decompress unit, and
wherein the data compress/decompress and transfer control circuit includes a register capable of storing a plurality of configuration data transmitted from the configuration data management unit, and based on the configuration data stored in the register, controls the data compress or decompress processing in the data compress/decompress unit, and controls the transfer of the data subjected to the data compress or decompress processing.

8. The semiconductor integrated circuit according to claim 1,
wherein the data transfer circuit includes:
a stream data processing circuit capable of transferring stream data; and
a stream data transfer control circuit capable of controlling the data transfer in the stream data processing circuit, and
wherein the stream data transfer control circuit includes a register capable of storing a plurality of configuration data transmitted from the configuration data management unit, and controls the data transfer in the stream data processing circuit based on the configuration data stored in the register.
